(19) United States
(12) Patent Application Publication
(10) Pub. No.: US 2005/0232648 A1
(43) Pub. Date: Oct. 20, 2005

(54) Color image forming apparatus

(75) Inventors: Kimio Nishizawa, Tokyo (JP); Yutaka Miyasaka, Tokyo (JP); Nobuyasu Tamura, Tokyo (JP); Kazutoshi Kobayashi, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Business Technologies, Inc., Tokyo (JP)

(21) Appl. No.: 10/992,019

(22) Filed: Nov. 17, 2004

(30) Foreign Application Priority Data
Apr. 15, 2004 (JP) JP2004-120859
Oct. 8, 2004 (JP) JP2004-296898

(51) Int. Cl. G03G 15/00

(52) U.S. Cl. 399/49

(57) ABSTRACT

A color image forming apparatus including: a plurality of developing devices for forming a black toner image and a color toner image; an image carrier for carrying toner images; a density detecting device for detecting densities of the black toner image and the color toner image each on the image carrier, the density detecting device having a light emitting element and a light sensitive element; and a controller for the density detecting device; wherein, when detecting a density of the black toner image, the controller controls a drive voltage of the light emitting element so that an amount of received light from a non-image area becomes a first predetermined value; and when detecting a density of the color toner image, the controller controls the drive voltage so that an amount of received light from a non-image area becomes a second predetermined value.

### BACKGROUND OF THE INVENTION

The present invention relates to the detection of the density of a black toner image and color toner images of yellow (Y), magenta (M) and cyan (C) carried by an image carrier, particularly to a color image forming apparatus for controlling the developing conditions of the developing device, based on the aforementioned density detection.

In recent years, a tandem type color copying machine, a color printer and a color multifunction device are used, wherein the photoconductors for forming toner image of various colors are arranged sequentially with respect to the intermediate transfer member, whereby color images are formed. These color image forming apparatuses each are provided with a photoconductor for each color, image writing apparatus, developing device, intermediate transfer member and secondary transfer section. When a color image is formed, the image is exposed to the photoconductor by the image writing apparatus for each color, based on the image information on each color, and an electrostatic latent image is formed. The electrostatic latent image formed on the photoconductor by the developing device is developed using toner for each color, and toner images of various colors are formed. The toner images of these colors on the photoconductor are primarily transferred on the intermediate transfer member sequentially, and the toner images of these colors are superimposed on the intermediate transfer member. The color toner images superimposed on the intermediate transfer member are collectively subjected to secondary transfer to paper, whereby color images are formed.

In the color image forming device of the aforementioned type, a developing condition control mode is applied on a regular or irregular basis. The developing condition control mode serves as follows: When the copying machine 100 has been turned off for a certain period of time or more, a specified number of image formation pages have been outputted, or the ambient humidity of the copying machine 100 has been changed in excess of a certain level, developing condition control is provided in such a way that the density of the patch toner image formed by the patch of a reference density is detected, and the developing conditions of the electrostatic latent image on the photoconductor by the developing device is changed in order to get the optimum amount of developed toner.

When the aforementioned developing condition control mode is activated, control is provided in such a way that a patch toner image by the reference density patch is formed on the photoconductor and this patch toner image is transferred to the intermediate transfer member, then the density of the patch toner image on the intermediate transfer member is detected and the developing condition of the electrostatic latent image on the photoconductor by the developing device is changed so that the optimum amount of developed toner can be ensured. A density detecting device is used to detect the density of the patch toner image. The density detecting device comprises a reflective optical sensor consisting of a light emitting element 61 and a light sensitive element 62, and a sensor drive control system for drive control.

In the prior art, when the density of a black toner image and color toner images of yellow (Y), magenta (M) and cyan (C) is detected, aforementioned density detecting device is used, and light is emitted by the light emitting element with a specified constant intensity.

FIG. 7 shows the detection characteristics when the density of a black toner image and color toner images of Y, M and C is detected by one density detecting device. FIG. 7 shows an example of the relation between the sensor detected voltage and the amount of toner on the intermediate transfer belt. In FIG. 7, the vertical axis denotes the sensor detected voltage Vs, while the horizontal axis represents the amount of toner on the intermediate transfer belt. The sensor detected voltage V0 is the sensor detected voltage of the intermediate transfer belt where there is no toner. The example of the output characteristic A-2 indicates an example of the output characteristic when the black patch toner image has been detected. The example of the output characteristic B-2 indicates an example of the output characteristic when the color patch toner image of Y as a typical example of the Y, M and C has been detected. The color patch toner images of the M and C also exhibits similar trend of output characteristics.

The example of output characteristic A exhibits a downward slope. When the amount of toner is increased on the intermediate transfer member, the sensor detected voltage Vs tends to decrease. In the meantime, the example of output characteristic B exhibits an upward slope. When the amount of toner is increased on the intermediate transfer member, the sensor detected voltage Vs tends to increase, contrary to the case of detecting the black patch toner image.

When one density detecting device is used to detect the density of a black toner image and color toner images of Y, M and C, the sensor detected voltage of all toner images must be kept within the range that can be detected by the density detecting device. In the prior art, the detection output range is divided into two; one for the black toner image and the other for the color toner images of Y, M and C. This arrangement causes the sensor output range to be restricted when one density detecting device is used for detection, and necessarily reduces the absolute detection sensitivity, with the result that detection accuracy is deteriorated.

As described above, the deteriorated detection accuracy leads to greater susceptibility to negative factors. For example, the Patent Document 1 discloses the art of resolving the change in the amount of reflected light due to the environmental change with time, thereby ensuring the detection accuracy conforming to the requirements in practical use.

According to the Patent Document 1, before detecting the amount of toner attached to the intermediate transfer member, the light emitting element is used to apply light to the top surface of the intermediate transfer member without toner attached thereto. The analytical curve is corrected based on the amount of reflected light detected by the light sensitive element, and the amount of the attached toner of the reference density patch is corrected, based on the corrected analytical curve, whereby detection accuracy is maintained despite the environmental change with time.

Patent Document 2 discloses that, when detecting the density of a black toner image and color toner images of Y, M and C, the amount of light emitted from the light emitting element is kept at a predetermined level, and the detecting device voltage from the light sensitive element is amplified at the amplification factors different between the black toner image and color toner image to get the sensor output value. This arrangement improves the detection sensitivity, according to the Patent Document 2.

In Patent Document 1, however, the detection output range is divided into two; one for the black toner image and the other for the color toner images. This method has the disadvantage of intrinsically poor detection accuracy.

In Patent Document 2, the amount of light emitted for detection is constant. When one amplification ratio is made greater than the other, there is necessarily an adverse effect of the noise, with the result that detection accuracy is deteriorated. Further, since amplification factor is changed between the black toner image and color toner image in the detection of the black toner image and color toner images, there is a problem of difference in detection accuracy between the black toner image and color toner image. Thus, the detection accuracy in any one of them has not yet improved, as compared to that of the previous method.

[Patent Document 1] Official Gazette of Japanese Patent Tokkaihei 11-38707

[Patent Document 2] Official Gazette of Japanese Patent Tokkaihei 11-160927

### SUMMARY OF THE INVENTION

The present invention has been made to solve the aforementioned problems. Accordingly, the object of the present invention is to provide a color image forming apparatus capable of ensuring a dynamic range required to detect the density of all color toner images, and detecting the color toner image density with higher accuracy, without complicating the apparatus configuration and detection control as compared to the prior art.

The aforementioned object can be achieved by a color image forming apparatus having the following features:

(1) A color image forming apparatus comprising: a plurality of developing devices for forming a black toner image and a color toner image; an image carrier for carrying the black toner image and the color toner image; a density detecting device for detecting densities of the black toner image and the color toner image each on the image carrier, the density detecting device comprising a light emitting element and a light sensitive element; and a controller for controlling the density detecting device; wherein, when the density detecting device detects a density of the black toner image carried by the carrier, the controller controls a drive voltage of the light emitting element so that an amount of received light at the time of detecting a non-image area on the carrier becomes a first predetermined amount of received light; and when the density detecting device detects a density of the color toner image carried by the carrier, the controller controls the drive voltage of the light emitting device so that an amount of received light at the time of detecting a non-image area on the carrier becomes a second predetermined amount of received light.

(2) The color image forming apparatus described in (1), wherein the aforementioned controller switches the drive voltage of the light emitting element, according to the black toner image and color toner images carried by the carrier.

(3) The color image forming apparatus described in (1) or (2), wherein the first predetermined amount of received light is set at a level higher than the level of the second predetermined amount of received light.

(4) The color image forming apparatus described in any one of (1) through (3), wherein the first reference detection voltage of the density detecting device corresponding to a first predetermined amount of received light and the second reference detection voltage corresponding to a second predetermined amount of received light are stored in the storage section.

(5) The color image forming apparatus described in any one of (1) through (4), wherein the density detecting device comprising an amplifier for amplifying an element detected voltage detected by the light sensitive element and outputting a sensor detected voltage, wherein the amplifier amplifies, with the same amplification factor, the element detected voltage outputted from the light sensitive element by detecting the density of the black toner image and the element detected voltage outputted from the light sensitive element by detecting the density of the color toner image, and the amplifier outputs the sensor detected voltage.

(6) The color image forming apparatus described in (5), wherein the number of the aforementioned amplifiers provided is one.

(7) The color image forming apparatus described in any one of (1) through (6), wherein the aforementioned density detecting device is a reflection type optical sensor.

(8) The color image forming apparatus described in any one of (1) through (7), wherein the drive voltage of the aforementioned light emitting element is corrected before the toner image density is detected by the density detecting apparatus

(9) The color image forming apparatus described in any one of (1) through (8), wherein the aforementioned controller controls to: detect the non-image area by applying an initial drive voltage prior to detecting a density of the black toner image or the color toner image by the density detecting device; correct the drive voltage of the light emitting element based on a result of detecting the non-image area; and detect the toner image density according to a corrected drive voltage is characterized by the steps of:

correcting the drive voltage of the light emitting element when detecting the non-image area according to the initial drive voltage prior to detecting the toner image density by the density detecting device, and when detecting the toner image density, based on the result of detection; and detecting the toner image density according to the corrected drive voltage.

(10) The color image forming apparatus described in (9), wherein the initial drive voltage of the light emitting element corresponding to a first predetermined amount of received light and the initial drive voltage of the light emitting element corresponding to a second predetermined amount of received light are stored in the storage section.

(11) The color image forming apparatus described in any one of (1) through (10), wherein the developing condition of the developing device is changed, based on the result of detection by the density detecting device.

(12) The color image forming apparatus described in (11), wherein the aforementioned developing condition represents development bias.

(13) The color image forming apparatus described in any one of (1) through (12), wherein the aforementioned carrier represents the intermediate transfer member.

The aforementioned arrangement allows the initial value of the density detecting signal to be set separately for each of the black toner image and color toner images, thereby ensuring the dynamic range required to detect the density of the toner images of all colors.

The prevent invention described above provides the dynamic range required to detect the density of the toner images of all colors, for the purpose of changing the amount of light received by the light sensitive element in the detection of the black toner image and color toner images. Moreover, the present invention permits detection of toner image density with higher accuracy, without complicating the apparatus configuration and detection control as compared to the prior art. This arrangement ensures economical configuration of a density detection control system, with the result that the production cost of a color color image forming apparatus can be cut down.

### BRIEF DESCRIPTION OF THE DRAWINGS

FIG. 1 is a conceptual diagram showing an example of the configuration of a color copying machine 100 as an embodiment of the present invention;

FIG. 2 is a block diagram showing an example of the configuration of the control system of the color copying machine 100 of the present invention;

FIG. 3 is a diagram representing an example of the configuration at the time of executing the development condition control mode, extracted from the color copying machine 100 of FIG. 1;

FIG. 4 is a block diagram representing an example of the configuration of a sensor drive control system 103;

FIG. 5 is diagram representing an example of the relationship between the sensor detected voltage and the amount of toner on the intermediate transfer belt;

FIG. 6 is a flowchart representing the development condition control in the copying machine 100; and

FIG. 7 is a diagram representing an output characteristic of ht sensor detected voltage of the density detecting device of a prior art.

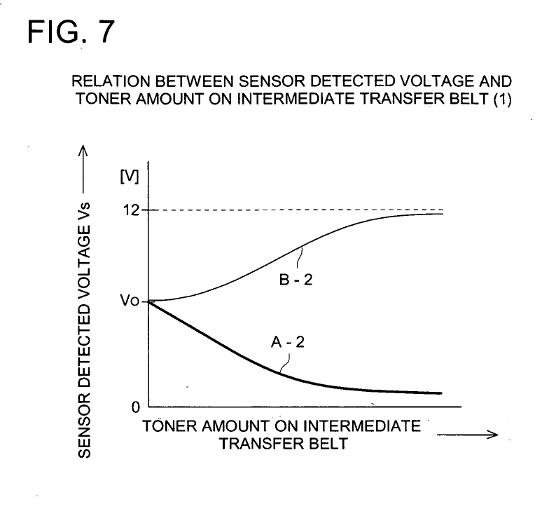

### DETAILED DESCRIPTION OF THE PREFERRED EMBODIMENT

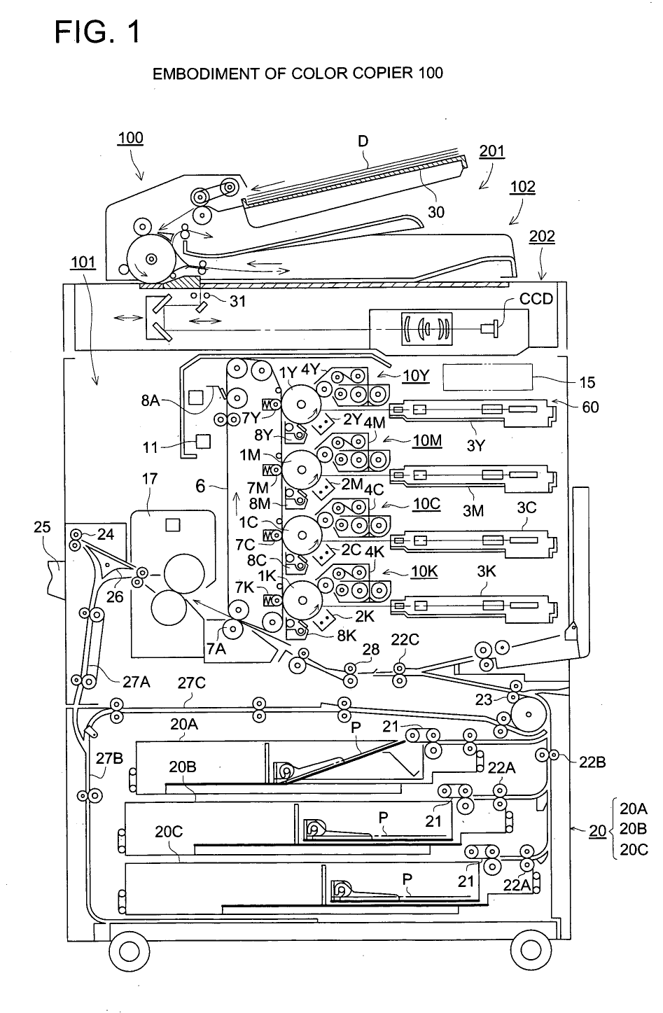

Referring to the drawings, the following describes the color copying machine 100 as an embodiment the present invention. FIG. 1 is a conceptual diagram showing an example of the configuration of a color copying machine 100 as an embodiment of the present invention;

In FIG. 1, the color copying machine 100 is composed of a copying machine proper 101 and a document reading apparatus 102. The document reading apparatus 102 is located on the copying machine proper 101, and is composed of an automatic document sheet feeding section 201 and reading section 202. The document D placed on a document accommodation tray 30 of the automatic document sheet feeding section 201 is fed by the conveyance section and thereafter document is exposed to light by the light source 31 of the reading section 202. The light reflected from the document is read as a document image by the line image sensor CCD.

The analog image signal subjected to photoelectric conversion by the line image sensor CCD undergoes analog processing, analog-to-digital conversion shading correction and image compression by the image processing section, and is turned into the digital image data D0. This image data is stored in the image memory and is then fed to the image writing units 3Y, 3M, 3C and 3K of respective colors.

The copying machine proper 101 comprises:

an image forming section 60 consisting of a plurality of sets of image forming units 10Y, 10M, 10C and 10K having the photoconductors of respective colors;

an endless intermediate transfer belt 6 as an intermediate transfer member on which the toner image of each color formed by a plurality of sets of image forming units 10Y, 10M, 10C and 10K is transferred;

a fixing apparatus 17 for fixing the toner image; and

a paper feeding section 20 for feeding the paper P for transferring a toner image to the image forming section 60. The density detecting device of the present invention is applicable to the aforementioned photoconductor or intermediate transfer member as an image carrier, however it is preferred to be applied to the intermediate transfer member. Both the development characteristics of the photoconductor by the developing device and the transfer characteristic or transfer from the photoconductor to the intermediate transfer member can be adjusted by detecting the density on the intermediate transfer member and feeding this information back to the development condition.

The paper feeding section 20 is arranged below the image forming section 60 and is composed, for example, of three paper feed cassettes 20A, 20B and 20C. To form an image on to the paper P fed from the paper feeding section 20, the image forming section 60 has four image forming units 10Y, 10M, 10C and 10K. The image forming unit 10Y for forming a yellow (Y) image contains a photoconductor 1Y for forming a yellow toner image, a charging device 2Y arranged around the photoconductor 1Y, an image writing unit 3Y, a developing device 4Y and a cleaning section 8Y.

The image forming unit 10M of magenta (M), image forming unit 10C of cyan (C) and image forming unit 10K of black (BK) has the same configuration as the aforementioned image forming unit 10Y of yellow (Y).

The charging device 2Y and image writing unit 3Y, the charging device 2M and image writing unit 3M, the charging device 2C and image writing unit 3C and the charging device 2K and image writing unit 3K constitute a latent image forming section. The development method by the developing devices 4Y, 4M, 4C and 4K is to apply the development bias obtained by superimposing AC(alternating current) voltage on the DC (direct current) voltage of the same polarity as that of the toner to be used—the negative polarity in the present embodiment. The intermediate transfer belt 6 is driven by a plurality of rollers and is rotatably supported by them, whereby a toner image of each of the Y, M, C and BK formed on the photoconductors 1Y, 1M, 1C and 1K is transferred.

The following describes the overview of the image forming process. The toner image of each of the colors formed by the image forming units 10Y, 10M, 10C and 10K is primarily transferred onto the rotating intermediate transfer belt 6 on a sequential basis by the primary transfer rollers 7Y, 7M, 7C and 7K to which the primary bias of the polarity opposite to that of the toner used—positive polarity in the present embodiment—is applied. A color toner image composed of toner images of various colors superimposed on one another is formed on the intermediate transfer belt 6. This color toner image is secondarily transferred to the paper P by the intermediate transfer belt 6.

The paper P stored in the paper feed cassettes 20A, 20B and 20C is fed to the paper feed cassettes 20A, 20B and 20C by a feed-out roller 21 and paper feed roller 22A, and is then conveyed to the secondary transfer roller 7A through the conveyance rollers 22B, 23 and 22C and registration roller 28. Thus, the color toner images are collectively transferred onto the paper P.

The paper P on which the color toner image is transferred is fixed by the fixing apparatus 17. Being sandwiched by the ejection roller 24, the paper P is ejected to the ejection tray 25 outside the machine. The remaining transfer toner remaining on the peripheral surface of the photoconductors 1Y, 1M, 1C and 1K after transfer is removed by the cleaning sections 8Y, 8M, 8C and 8K, and the system enters the next image forming cycle.

In the case of duplex image formation, a color toner image is formed on one side of the paper P, and the paper P ejected from the fixing apparatus 17 is branched off by a branching section 26. It is then fed to the paper feed path 27A located below. After having been reversed by the reversing conveyance path 27B, the paper P is conveyed to the registration roller through a paper re-feed path 27C. The reversed paper P is again fed to the secondary transfer roller 7A from the registration roller 28, and color toner images are collectively transferred onto the reverse side of the paper P.

After the color toner image has been transferred onto the paper P by the secondary transfer roller 7A, the remaining toner is removed from the intermediate transfer belt 6 by the cleaning section 8A.

A density detecting device 11 is arranged upstream from the aforementioned cleaning section 8A. It detects the density of the toner image, on the intermediate transfer belt 6, formed by the image forming section 60, and outputs the sensor output voltage Vs. A reflection type optical sensor is used for the density detecting device 11.

The color image forming apparatus has two modes; a normal mode for normal image formation and a developing condition control mode for changing the developing condition into the appropriate one. The copying machine proper 101 is provided with a controller 15. When the color copying machine 100 has been stopped for more than a predetermined time, a predetermined number of the image formed pages have been outputted, or the ambient humidity of the color copying machine 100 has been changed in excess of a certain level, the density of the patch toner image transferred onto the intermediate transfer belt 6 is detected and the developing condition control mode is activated. In this developing condition control mode, the controller 15 controls the drive voltage of the density detecting device 11 in response to the type of the color toner image carried on the intermediate transfer belt 6, whereby the color toner image density is detected.

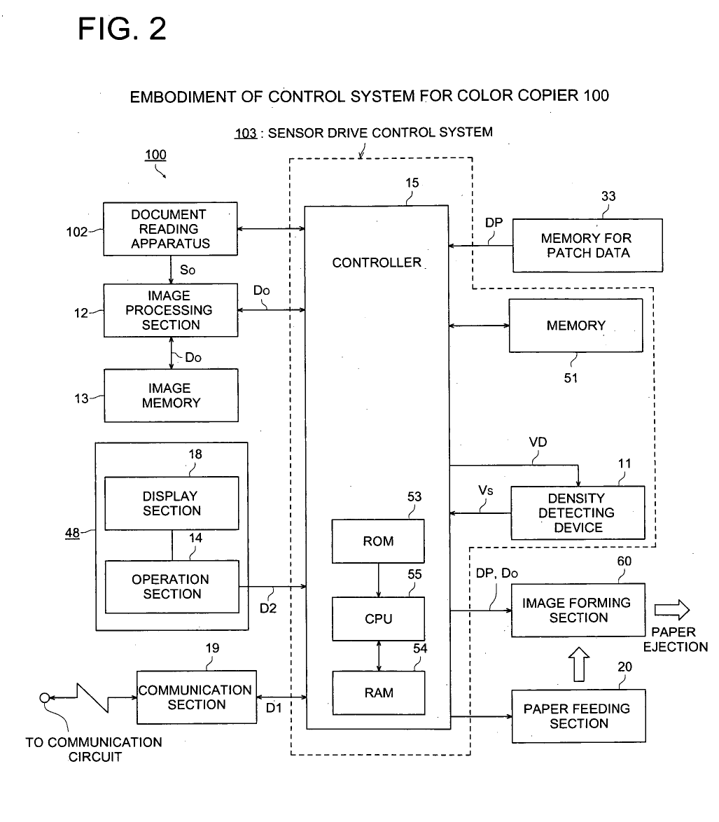

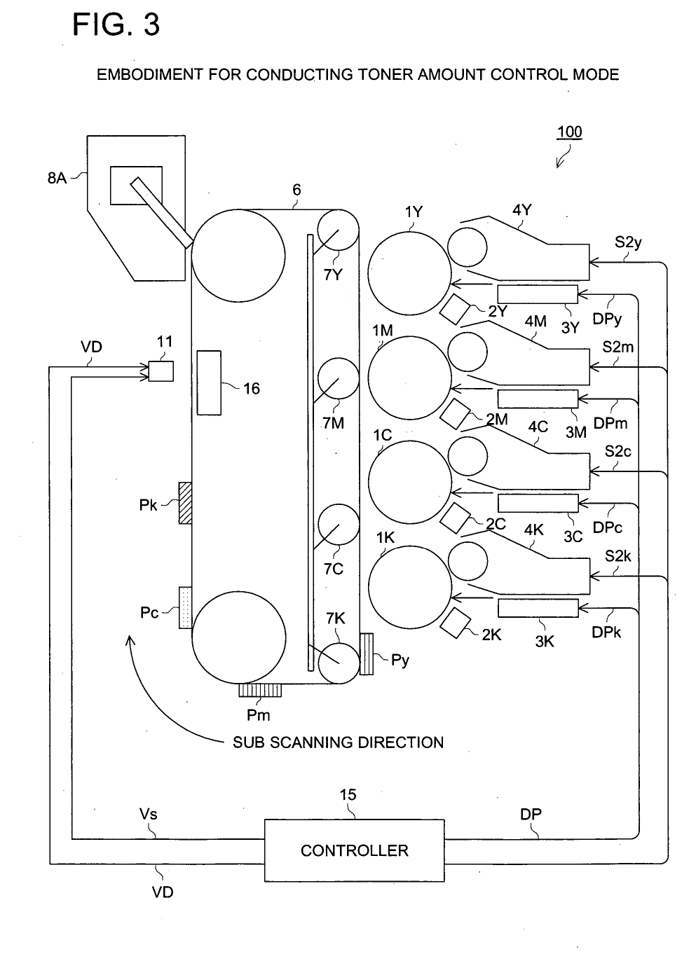

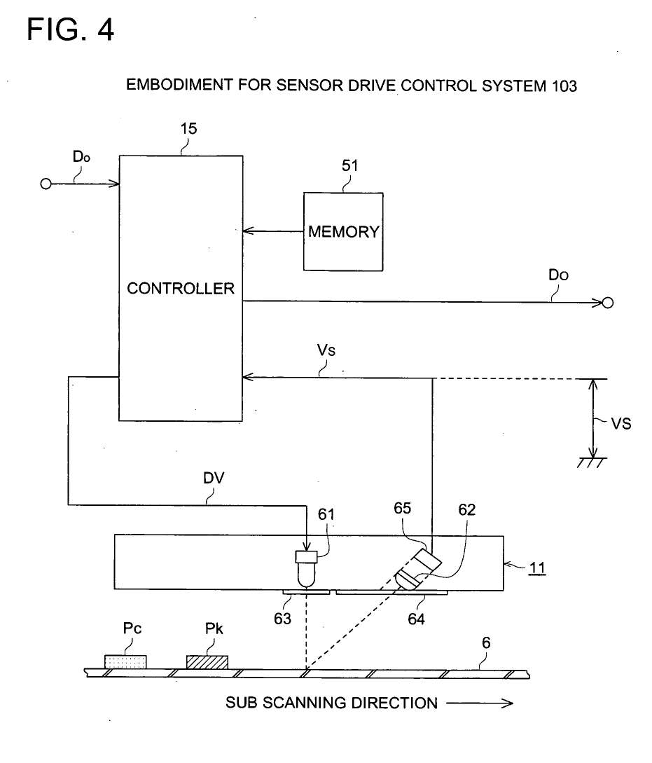

FIG. 2 is a block diagram showing an example of the configuration of the control system of the color copying machine 100. FIG. 3 is a diagram representing an example of the configuration at the time of executing the development condition control mode, extracted from the color copying machine 100 of FIG. 1. FIG. 4 is a block diagram representing an example of the configuration of a sensor drive control system 103. In the color copying machine 100 shown in FIG. 2, the portion enclosed by the dashed line represents the sensor drive control system 103, and is composed of the density detecting device 11, controller 15 and memory 51. (See FIG. 4).

The controller 15 shown in FIG. 2 has a ROM (Read Only Memory) 53, a RAM (Random Access Memory) 54 for work, and CPU (Central Processor Unit) 55. The ROM 53 incorporates a system control program for controlling the entire color copying machine. The RAM 54 temporarily stores the control command and others during execution of each mode. When the power has been turned on, the CPU 55 reads the system control program from the ROM 53 and starts the system, thereby controlling the entire color copying machine.

The CPU 55 controls execution of the normal mode and developing condition control mode.

The controller 15 is connected with a document reading apparatus 102, image processing section 12, image memory 13, communication section 19, paper feeding section 20, operation panel 48 and image forming section 60. The document reading apparatus 102 reads the image of the document G shown in FIG. 1, and outputs the image data S0 for the red (R), green (G) and blue (B). The document reading apparatus 102 is connected with the image processing section 12, to which the image data S0 is inputted to perform image processing. For example, the image processing section 12 allows the image data S0 for the R, G and B to be color-converted into the color image data Do consisting of the image data Dy for Y, image data Dm for M, image data Dc for C and image data Dk for BK.

Further, the operation panel 48 contains an operation section 14, connected to the controller 15, consisting of a touch panel, and a display section 18 composed of a liquid crystal display panel. A GUI (Graphical User Interface) based input tool is used for the operation panel 48. The power switch is arranged on the operation panel 48. Interlocked with the operation section 14, the display section 18 performs display operations. When selecting the image formation condition and paper feed cassettes 20A, 20B and 20C, the operation panel 48 is used. The image formation conditions and others set on the operation panel 48 are outputted to the CPU 55 in the form of operation data D2.

The controller 15 is connected with the communication section 19, and communicates with the external device linked with the color copying machine 100. For example, the color image formation data D1 sent from the high-order personal computer is sent to the image memory 13 or image processing section 12.

The controller 15 is connected with the paper feeding section 20 and provides control in such a way that the paper having the size set on the operation panel 48 is fed to the image forming section 60. In the normal mode, the image forming section 60 forms color images according to the image data Dy for Y, image data Dm for M, image data Dc for C and image data Dk for BK based on the image data Do read from the image memory 13 or the image data D1 sent from the external device.

In the developing condition control mode, the image forming section 60, a patch toner image of each color is formed on the photoconductors 1Y, 1M, 1C and 1K shown in FIG. 1. In this example, the memory 33 for the patch data of each color is connected to the controller 15 and stores the patch data DP for forming a color patch toner image of the Y, M, C and BK. In the developing condition control mode, the patch data DP is placed under the reading control of the controller 15 and is sent to the image forming section 60.

The patch data DP consists, for example, of the patch data DPy for forming an Y patch toner image, patch data DPm for forming an M patch toner image, patch data DPc for forming a C patch toner image and a patch data DPk for forming a BK patch toner image.

In this example, the color copying machine 100 shown in FIG. 3 allows a black patch toner image or patch toner images of various colors to be formed on the intermediate transfer belt 6 in the developing condition control mode.

In FIG. 3, the photoconductor 1Y for Y is charged to have a predetermined potential by the charging device 2Y. The image writing unit 3Y applies the laser beam to the photoconductor 1Y having been changed, based on the patch data DPy, and forms a patch electrostatic latent image for Y. The developing device 4Y develops the patch electrostatic latent image by Y toner. This development causes a Y patch toner image Py to be formed on the photoconductor 1Y.

Similarly, an M patch toner image Pm is formed on the photoconductor 1M for M, based on the patch data DPm. A C patch toner image Pc is formed on the photoconductor 1C for C, based on the patch data DPc, and a BK patch toner image Pk is formed on the photoconductor 1K for BK, based on the patch data DPk.

The patch toner image of each color formed on each photoconductor is transferred onto the intermediate transfer belt 6. The patch toner image of each color after having been transferred is fed to the density detecting device 11 when the intermediate transfer belt 6 moves in the sub-scanning direction.

To improve detection accuracy by keeping a predetermined distance always between the density detecting device 11 and intermediate transfer belt 6, it is preferred that the a belt tensioning member 16 be arranged on side opposite to the density detecting device 11 sandwiching, and a belt tensioning member 16 be brought in contact with the intermediate transfer belt 6 in order to ensure a belt running stability.

The density detecting device 11 detects the density of the patch toner image of each color transferred onto the intermediate transfer belt 6, and outputs the sensor detected voltage Vs to the controller 15. When detecting the density of each color patch toner image, the controller 15 controls the drive voltage VD of the light emitting element, thereby controlling the sensor detected voltage Vs.

For example, before detecting the density, the controller 15 allows the light emitting element to be driven and controlled at the initial drive voltage VD 01 or VD 02 for BK and YMC so that light is applied to the non-image area devoid of a toner image on the intermediate transfer belt, and corrects the drive voltage of the-light emitting element 61 in such a way that the sensor detected voltage Vs outputted from the light sensitive element 62 will be equal to the reference detection voltage V1 or V2, whereby the amount of light is adjusted.

FIG. 4 is a block diagram representing an example of the configuration of a sensor drive control system 103, extracted from the example of the configuration of the color copying machine 100 in FIG. 2. The sensor drive control system 103 is composed of the controller 15, density detecting device 11 and document 51.

The reference detection voltage V1 for BK, the reference detection voltage V2 for YMC, the initial drive voltage VD 01 for BK, the YMC initial drive voltage VD 02 common to YMC, the corrected drive voltage VD1 for BK, and the corrected reference detecting voltage V2 common to YMC are stored as voltage setting information in the memory 51. The reference detecting voltage V1 for BK is set higher than the YMC reference detecting voltage common to YMC.

This example refers to the case where four colors—Y, M, C and BK—are used for the toner image formed on the intermediate transfer belt 6. The value of the sensor detected voltage Vs is such that the BK is set to the highest voltage value, and the other Y, M and C colors are set to the same voltage values, which are lower than that of the BK.

The controller 15 selects either the reference detection voltage Vl for BK or the reference detection voltage V2 for YMC from the memory 5, according to BK or YMC. The controller. 15 reads it from the memory 51 and set it.

The density detecting device 11 is connected to the controller 15. The density detecting device 11 detects the toner image on the intermediate transfer belt 6 and outputs the sensor detected voltage Vs to the controller 15. The density detecting device 11 uses a reflection type optical sensor equipped with a light emitting element 61 and light sensitive element 62. The light emitting element 61 has a diffusion plate 63 provided with a window (not illustrated). The light sensitive element 62 also has a diffusion plate 64 provided with a window (not illustrated). The voltage of the detecting device voltage obtained from the light sensitive element 62 is amplified by an amplifier 65 and is used as a sensor detected voltage.

When detecting the density of the BK toner image, the controller 15 reads the reference detection voltage V1 and the initial drive voltage VD 01 for BK before starting the detection of the density, and sets the drive voltage VD to the initial drive voltage VD 01. Then it drives the light emitting element first at the initial drive voltage VD 01 for the BK and detects the density of the intermediate transfer member where a toner image is not formed, whereby the sensor detected voltage Vs is acquired. The sensor detected voltage Vs having been acquired is compared with the reference detection voltage V1, and a check is made to determine if the reference detection voltage V1 agrees with the reference detection voltage V1. For example, if the reference detection voltage V1 fails to agree with the reference detection voltage V1, then the controller 15 corrects the drive voltage VD of the light emitting element 61 so that the sensor detected voltage Vs will become equal to the reference detection voltage V1, and adjusts the amount of light emitted from the light emitting element 61.

Further, when detecting the density of the YMC toner images, the controller 15 reads the reference detection voltage V2 for YMC and YMC initial drive voltage VD 02 before starting the density detection, and sets the drive voltage VD to the initial drive voltage VD 02. In the same manner as when detecting the BK toner image, the controller 15 corrects the drive voltage VD of the light emitting element 61 so that the sensor detected voltage Vs will become equal to the reference detection voltage V2, and adjusts the amount of light emitted from the light emitting element 61. As described above, the controller 15 ensures a higher sensitivity in the detection of the density of the toner image, in response to a change in the amount of toner at the time of detecting the toner image, by initial correction of the drive voltage VD of the density detecting device 11.

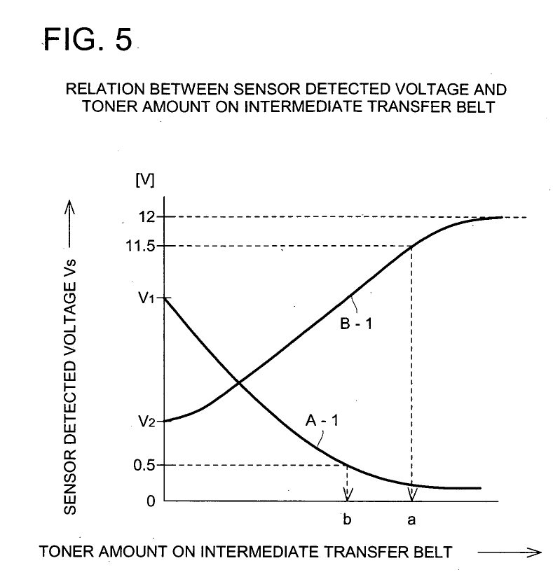

FIG. 5 shows the relationship between the sensor detected voltage and the amount of toner on the intermediate transfer belt in the present invention. In FIG. 5, the vertical axis represents the sensor detected voltage Vs in the density detecting device 11 and the horizontal axis denotes the amount of toner on the intermediate transfer belt 6. “A” denotes an example of the output characteristic when detecting the BK patch toner image, while “B” indicates the output characteristic when detecting the color patch toner image,

In this example, the reference detection voltage V1 is set as the sensor detected voltage Vs when detecting the density of the BK patch toner image. To put it another way, in the example of the output characteristic A-1 during the detection of the BK patch toner image, the sensor detected voltage Vs where there is no toner on the intermediate transfer belt 6 is same as the reference detection voltage V1.

Further, the sensor detected voltage V0 is set as the sensor detected voltage Vs when detecting the density of the YMC patch toner image. To put it another way, in the example of the output characteristic B-1 during the detection of the YMC patch toner image, the sensor detected voltage Vs where there is no toner on the intermediate transfer belt 6 is same as the reference detection voltage V2. The reference detection voltage V1 in the detection of the density of the BK patch toner image is set higher than the reference detection voltage V2 of other Y, M and C patch toner images.

In this example, the full detection range of the light sensitive element 62 in the density detecting device 11 is 0 through 12 volts. In the example of the output characteristic A-1, the area close to the output lower limit exhibits a non-linear saturation characteristic. Further, in the example of the output characteristic B-1, the area close to the output upper limit exhibits a non-linear saturation characteristic.

In the execution of the developing condition control mode, the maximum the amount of toner of the YMC patch toner image required on the intermediate transfer belt 6 is assumed as “a”, and the maximum the amount of toner of the BK patch toner image is assumed as “b”. In this case, 0.5 volts in excess of the maximum amounts of toner “a” and “b” are removed from the detection range as the characteristic of the light sensitive element.

Accordingly, the area that can be used as a valid detection area in the detection of the density of the BK patch toner image is from the reference detection voltage V1 to the sensor detected voltage Vs=0.5 [V]. Similarly, the area that can be used as a valid detection area in the detection of the density of the YMC patch toner image is from the reference detection voltage V2 to the sensor detected voltage Vs=11.5 [V].

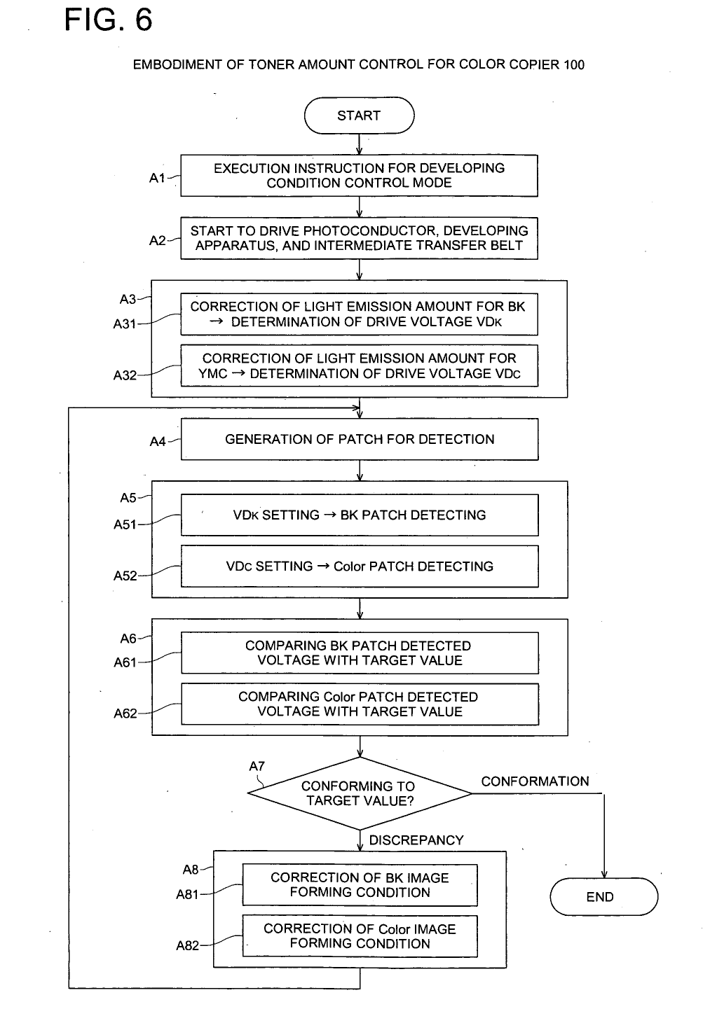

The following describes the developing condition control mode in the color copying machine. FIG. 6 is a flowchart for executing the development condition control mode in the copying machine 100. In this embodiment, an example will be taken from the cases where the developing condition control mode is executed when the color copying machine 100 has been stopped for more than a predetermined period of time, a predetermined number of the printed pages have been outputted, or the humidity around the copying machine has changed in excess of a predetermined level. In this example, the drive voltages V Dk and VDc of the density detecting device 11 are determined in Steps A1 through A3. Then the developing condition control mode is executed while the drive voltage is switched over to the aforementioned drive voltages V Dk and VDc in Steps A4 through A8. This will be mentioned in the following example.

In the Step A1 of the flowchart given in FIG. 6, the controller 15 issues the developing condition control mode execution command to the image forming section 60 and sensor drive control system 103. The developing condition control mode execution command is issued in response to the information to the effect that the color copying machine 100 has been stopped for more than a predetermined period of time, a predetermined number of the printed pages have been outputted, or the humidity around the copying machine has changed in excess of a predetermined level.

In the Step A2, the image forming section 60 and sensor drive control system 103 start operations based on the developing condition control mode execution command. In this case, the photoconductors 1Y, 1M, 1C and 1K shown in FIGS. 1 and 3 and developing devices 4Y through 4C are driven, and the charging devices 2Y, 2M, 2C and 2K are activated. The primary transfer rollers 7Y through 7K and intermediate transfer belt 6 are driven by the belt drive apparatus (not illustrated) and others.

In Step A3, initial drive voltage VD₀ₖ is first supplied to the light emitting element 61 of the density detecting device 11 to start emission of light. The density detecting device 11 detects the surface of the belt tensioning member 16 without toner attached thereto, and outputs the sensor detected voltage Vs to the controller 15. In this case, the reference detection voltage V1 for the BK and reference detection voltage V2 for YMC are read from the memory 51. Further, the controller 15 selects and sets either the reference detection voltage V1 for BK or reference detection voltage V2 for YMC, based on the information on the toner color to be corrected.

The controller 15 compares the detected sensor detected voltage Vs for BK with reference detection voltage V1 to determine if they agree with each other or not. For example, if they fail to agree with each other, the controller 15 variably controls the drive voltage VD of the light emitting element 61 so that the sensor detected voltage Vs will become equal to the reference detection voltage V1, and adjusts the amount of light emitted from the light emitting element 61. This adjustment of the amount of light allows the controller 15 to determine the drive voltage V Dk at the time of detecting the density of the BK patch toner image Pk in Step A31.

This is followed by the Step A32 wherein the controller 15 compares the reference detection voltage V2 for YMC with the sensor detected voltage Vs to determine if they agree with each other or not. If they fail to agree with each other, the controller 15 variably controls the drive voltage VD of the light emitting element 61 so that the sensor detected voltage Vs will become equal to the reference detection voltage V2, and adjusts the amount of light emitted from the light emitting element 61. This adjustment of the amount of light allows the controller 15 to determine the drive voltage V Dc at the time of detecting the density of the patch toner images Py, Pm and Pc of various colors in Step A32. The drive voltages V Dk and V Dc determined in this Step are stored in the RAM 54. When the drive voltage is switched, these drive voltages V Dk and V Dc are read from the RAM 54 and are utilized.

Upon completion of the processing up to Step A3, the controller 15 proceeds to the patch forming operation for density detection in Step A4. The controller 15 reads the patch data P out from the memory 33 for patch data.

The image forming section 60 having proceeded to the Step A5 writes the density detection patches to the photoconductors 1Y, 1M, 1C and 1K shown in FIG. 1, based on the write control signal S2 from the controller 15. The patch latent images formed on the photoconductors 1Y, 1M, 1C and 1K are developed with a predetermined bias applied to the developing devices 4Y, 4M, 4C and 4K, whereby patch toner images Py, Pm, Pc and Pk of the colors Y, M, C and BK are formed on the photoconductors.

These patch toner images Py, Pm, Pc and Pk of the colors Y, M, C and BK are sequentially transferred to the intermediate transfer belt 6 on the primary basis. The patch toner Py, Pm, Pc and Pk for each color is transferred to the intermediate transfer belt 6 are carried by the intermediate transfer belt 6, and are transported to the density detecting device 11, with the movement of the intermediate transfer belt 6 in the sub-scanning detection.

In Step A51, the controller 15 reads the corrected drive voltage V Dk for BK from the RAM 54 and sets it. Then the BK patch toner image Pk is detected by the density detecting device 11 and the sensor detected voltage Vs is outputted.

In Step A52, the controller 15 reads the corrected drive voltage V Dk for YMC from the RAM 54 and sets it. Then the density of the YMC patch toner images Pc, Pm, Py is detected by the density detecting device 11 and the sensor detected voltage Vs is outputted. Whether the toner image sent to the density detecting device 11 is the color patch toner images Pc, Pm and Py or the BK patch toner image Pk in this case is determined by the time elapsed from the write start command. According to the aforementioned elapsed time, the controller 15 provides control in such a way as to switch between the drive voltage V Dk and V Dc for determining the amount of light issued from the LED inside the density detecting device 11. Based on the drive voltage switching control, the density detecting device 11 detects the density of each of the color patch toner images Pc, Pm and Py, and outputs the toner detection voltage Vs.

Proceeding to the Step A6, the controller 15 executes the developing condition control mode. For example, it compares the sensor detected voltage Vs at the time of detecting the BK patch toner image Pk in Step A61 with the toner amount target value prepared in advance. Further, the toner detection voltage Vs when detecting the density of each of the color patch toner images Pc, Pm and Py in the Step A62 in a color printer, color digital copying machine, multifunction device and others, is compared with the toner amount target value prepared in advance.

After that, proceeding to the Step A7, the controller 15 checks whether or not the toner detection voltage Vs on the BK patch toner image Pk agrees with the toner amount target value, and whether or not the toner detection voltage Vs on the color patch toner images Pc, Pm and Py agrees with the toner amount target value. The toner amount target value is stored, for example, in the memory 51 in advance and is read from the memory 51. If there is agreement between the toner detection voltage Vs and toner amount target value, with respect to the BK patch toner image Pk and the color patch toner images Pc, Pm and Py, then the developing condition control mode terminates.

Further, if there is any disagreement between the toner detection voltages Vs and toner amount target values in the BK patch toner image Pk and color patch toner images Pc, Pm and Py, the controller 15 proceeds to Step A8 and executes a change of the developing condition. For example, in the BK patch toner image Pk, the BK color patch developing condition is changed in the Step A81. If the amount of toner is small, the controller 15 makes a change in such a way as to increase the development bias of the developing device 4K by the required level in order to increase the amount of toner. Conversely, if the amount of toner is great, the controller 15 makes a change in such a way as to decrease the development bias of the developing device 4K by the required level in order to decrease the amount of toner.

Similarly, in the color patch toner images Pc, Pm and Py, the YMC color patch developing condition is changed in the Step A82. If the amount of toner is small, the controller 15 makes a change in such a way as to increase the development bias of the developing device 4C by the required level in order to increase the amount of toner. Conversely, if the amount of toner is great, the controller 15 makes a change in such a way as to decrease the development bias of the developing device 4C by the required level in order to decrease the amount of toner. The same procedure applies to other M and Y patch toner images Pm and Py.

After changing the developing condition, the controller 15 goes back to the Step A4, and the same processing is repeated until there is an agreement between the toner detection voltage Vs and toner amount target value.

As described above, when developing the electrostatic latent image written in the photoconductors 1Y, 1M, 1C and 1K is developed, detecting the density of the BK patch toner image Pk and YMC patch toner images Pc, Pm and Py, and executing the developing condition control mode, the color copying machine 100 as an embodiment of the present invention allows the controller 15 to provide control in such a way as to drive the light emitting element at different drive voltages VD, in conformity with type of the BK patch toner image Pk and YMC patch toner images Pc, Pm and Py.

When detecting the density of the BK patch toner image Pk, the controller 15 provides control in such a way as to supply the drive voltage V Dk such that the reference detection voltage V0 can be obtained. Moreover, when detecting the density of the YMC patch toner images Pc, Pm and Py, the controller 15 provides control in such a way as to supply the drive voltage V Dc such that the reference detection voltage V1 can be obtained, wherein this reference detection voltage V1 is lower than the reference detection voltage V0 for detecting the density of the BK patch toner image Pk.

Thus, the present invention allows separate setting to the reference detection voltage V1 or V2, for each of the BK patch toner image Pk and YMC patch toner images Pc, Pm and Py. This arrangement makes it possible to ensure the dynamic range required for the detection of the density of all the Y, M, C and BK patch toner images. Moreover, the reference detection voltage V1 at the time of detecting the density of the BK patch toner image Pk is set higher than the reference detection voltage V2 at the time of detecting the density of the color patch toner images. This arrangement ensures high-precision density detection of both the BK patch toner image and color patch toner images. Further, as compared with the prior art, the present invention forms and outputs a highly stabilized color image, without complicating the apparatus configuration or detection control. Thus, the present invention provides a less expensive configuration of the density detection control system, and contributes to cost cutting of a color copying machine and related apparatuses.

When developing an electrostatic latent image written in the photoconductor, the present invention is extremely suitable for use in a color printer, color digital copying machine, multifunction device and others wherein the density of a toner image is detected on a regular or irregular basis and the developing condition control is executed.

1. A color image forming apparatus comprising:
a plurality of developing devices for forming a black toner image and a color toner image;
an image carrier for carrying the black toner image and the color toner image;
a density detecting device for detecting densities of the black toner image and the color toner image each on the image carrier, the density detecting device comprising a light emitting element and a light sensitive element; and
a controller for controlling the density detecting device;
wherein, when the density detecting device detects a density of the black toner image carried by the carrier, the controller controls a drive voltage of the light emitting element so that an amount of received light at the time of detecting a non-image area on the carrier becomes a first predetermined amount of received light; and when the density detecting device detects a density of the color toner image carried by the carrier, the controller controls the drive voltage of the light emitting device so that an amount of received light at the time of detecting a non-image area on the carrier becomes a second predetermined amount of received light.

2. The color image forming apparatus of claim 1, wherein the controller switches the drive voltage of the light emitting element, according to the black toner image and the color toner image carried by the carrier.

3. The color image forming apparatus of claim 1, wherein the first predetermined amount of received light is set at a level higher than a level of the second predetermined amount of received light.

4. The color image forming apparatus of claim 1, further comprising a storage section, wherein a first reference detection voltage of the density detecting device corresponding to the first predetermined amount of received light and a second reference detection voltage corresponding to the second predetermined amount of received light are stored in the storage section.

5. The color image forming apparatus of claim 1, wherein the density detecting device comprising an amplifier for amplifying an element detected voltage detected by the light sensitive element and outputting a sensor detected voltage,
wherein the amplifier amplifies, with the same amplification factor, the element detected voltage outputted from the light sensitive element by detecting the density of the black toner image and the element detected voltage outputted from the light sensitive element by detecting the density of the color toner image, and the amplifier outputs the sensor detected voltage.

6. The color image forming apparatus of claim 5, wherein the density detecting device comprises only one of the amplifier.

7. The color image forming apparatus of claim 1, wherein the density detecting device is a reflection type optical sensor.

8. The color image forming apparatus of claim 1, wherein the drive voltage of the light emitting element is corrected before a density of the black toner image or the color toner image is detected by the density detecting apparatus.

9. The color image forming apparatus of claim 1, wherein the controller controls to:
detect the non-image area by applying an initial drive voltage prior to detecting a density of the black toner image or the color toner image by the density detecting device;
correct the drive voltage of the light emitting element based on a result of detecting the non-image area; and
detect the toner image density according to a corrected drive voltage.

10. The color image forming apparatus of claim 9, further comprising a storage section, wherein a first initial drive voltage of the light emitting element corresponding to a first predetermined amount of received light and a second initial drive voltage of the light emitting element corresponding to a second predetermined amount of received light are stored in the storage section.

11. The color image forming apparatus of claim 1, wherein a developing condition of a developing device is changed, based on a result of detection by the density detecting device.

12. The color image forming apparatus of claim 11, wherein the developing condition comprises a development bias.

13. The color image forming apparatus of claim 1, wherein the carrier is an intermediate transfer member.
